(19) United States
(12) Patent Application Publication
(10) Pub. No.: US 2003/0122864 A1
(43) Pub. Date: Jul. 3, 2003

(54) Method and apparatus for displaying commercial messages during a user waiting time

(76) Inventors: John Erven Jenne, Houston, TX (US); Sompong Paul Olarig, Pleasanton, CA (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 10/038,674

(22) Filed: Dec. 31, 2001

(51) Int. Cl. G09G 5/00

(52) U.S. Cl. 345/738

(57) ABSTRACT

A computer system is adapted to display commercial messages during a user waiting time. Display of the commercial messages is controlled by Basic Input/Output System (BIOS) code during boot-up time and is controlled by a commercial messaging application once the computer system may be under control of the operating system. A non-volatile memory containing the commercial messages may be updated securely through the Internet. Examples of user waiting times include software installation time, screen saver time, download time for a large set of files, virus scanning time, entry time for a lower power mode and wake-up time from the low power mode.

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention generally relates to computer displays of commercial messages and more particularly to displaying commercial messages during a user waiting time when using the computer.

2. Description of the Related Art

A personal computer (PC)-based system software generally has two main components: The Basic Input/Output System (BIOS) and the operating system (OS). The BIOS is actually a series of complex programs that are stored in the ROM (Read Only Memory) that come with the computer. When a computer is powered-on or re-booted, the processor reads from a fixed memory address. This fixed memory address typically points to a flash memory device that stores BIOS. The BIOS provides three important functions:

1. The BIOS contains the Power On Self Test (POST), which executes automatically every time the computer is turned on. The POST checks out various hardware components of the computer, including the memory, in order to find any computer hardware and peripheral problems before using the PC.

2. The BIOS contains special programs called device drivers that provide a set of standard interfaces to the various hardware devices. A device driver operates at the level of the hardware. Generally speaking, device drivers save the programmers time from having to understand the characteristics of the various hardware devices.

3. The BIOS also provides a collection of useful services such as interrupts. However, with only a few exceptions, most of the services are used by the operating system.

Historically, for servers with relatively large number of devices (I/O and memory), the POST time takes several minutes to complete. The POST time is expected to become worse for the coming generations of PCs and servers. For example, the Itanium processor-based systems are expected to use boot-up time that is much longer than the Pentium-based machines. This is primarily due to the fact that the Itanium processors contain considerably more transistors and perform many more self tests on systems because of many enhanced capabilities introduced in the new processors. Other examples of factors that contribute to increase in the boot-up time include: number of drives to be mapped, number of independent BATCH files to be executed, and the number and type of drivers for the attached peripherals

During a computer boot-up time or a wake-up time from a low-power mode, the computer user is forced to sit and wait. Other common user waiting periods include, for example, a virus scan period. Currently, during the user waiting time, a computer manufacturer typically displays its manufacturer logo and/or results from system tests. Such information provides little value to the user or the manufacturer.

### BRIEF SUMMARY OF THE INVENTION

Commercial messages are displayed on a computer display during the user waiting time, like booting, waking up from sleep mode or, similar events. In the illustrated technique, the commercial messages stored in a non-volatile memory location are selected and displayed during the user waiting time. Each message may be assigned a time weight and a frequency weight. A processor is associated with a computer display, a non-volatile memory having commercial messages, a commercial message application, an advertisement BIOS code, and an Internet web browser. The commercial messages in the non-volatile memory may be securely updated through the Internet using a password.

### BRIEF DESCRIPTION OF THE SEVERAL VIEWS OF THE DRAWINGS

A better understanding of the present invention can be obtained when the following detailed description of some embodiments is considered in conjunction with the following drawings in which:

FIG. 1 is a flowchart of an exemplary technique of displaying a commercial message on a computer display.

FIG. 2 is a diagram of an exemplary system of assigning duration and frequency of displaying commercial messages on a computer display using the technique of FIG. 1.

FIG. 3 is an exemplary embodiment of a computer system for displaying a commercial message on a video display for implementing the exemplary technique of FIG. 1.

### DETAILED DESCRIPTION OF THE INVENTION

Internet sites generate revenue by placing advertisements on their websites. Revenue is generated from fees for placing the advertisements and from referral. Advertisements have traditionally been displayed through webservers when a user is on the Internet. A user may find such advertisements of no value or may be directed to other advertisements through links, which may or may not lead the user to any valuable information. In the process of browsing around the user may lose track of the original site to which he may never return. In other scenarios, pop-up banners appear that distract the user and are necessarily of an intrusive nature. However, if advertisements were based on user's interest determined by the user inputs stored in a user profile, the likelihood of viewing those advertisements is greatly enhanced. Moreover, the commercial message display during a user waiting period only is non-intrusive and, thus, the illustrated technique effectively uses a captive audience for revenue enhancement for computer manufacturers through commercial messages and entertainment.

Advertising could generate additional revenue for the computer manufacturer. Instead of displaying the conventional status results during the user's idle or waiting period, advertisements for online shopping, Internet Service Providers (ISPs), magazines, automobiles, computer services, computer hardware or software updates etc. could be displayed. The following discussion relates, in general, to commercial messages in a broad sense, however, when appropriate, the term advertisement is used for illustrative examples and refers generally to other commercial messages as well.

A software application could track users' preferences or favorite subjects. This information could be used to download advertisements from the computer manufacturers or manufacturer's authorized websites that are tailored to the users' interests. By adapting the advertisements to the user, the likelihood that the user will seek more information about the product or services is improved. This efficiency increases the advertisement revenue due to referrals.

If the advertisements were simply displayed with a software application, the computer user could uninstall or delete the commercial message application. A user, however, is highly unlikely to uninstall critical utilities like virus scan, file downloads and software installation utilities during whose execution the user faces unavoidable waiting periods. During such periods the user is a captive audience for useful and entertaining commercial messages. Techniques illustrated herein enable computer manufacturers to display advertisements during system boot-up, when waking up from the sleep mode, or other waiting periods like during a virus scan, screen saver, long file downloads, software installation or Scan Disk. By using a flash read-only memory (ROM) or other suitable memory, the advertisements could be updated regularly. This would generate an advertisement revenue stream from every computer sold with this feature.

Besides generating revenue, the user may be entertained during boot-up, the wake-up period or other waiting times. Instead of the traditional manufacturer logo or test status, the users get to see an informative advertisement tailored to their interests. By entertaining the user, the boot-up or wake-up delay does not seem to be as long, thus improving customer satisfaction. Besides advertisements, other information could be displayed such as announcements, useful productivity tips, utility enhancements and computer upgrades. By mixing the content displayed, it increases the likelihood of keeping the users attention. The user may sit through an advertisement if the user knows that there is going to be a useful tip or information afterwards. Other techniques to maintain the user interest can be used to make the user wait time entertaining, productive and revenue enhancing.

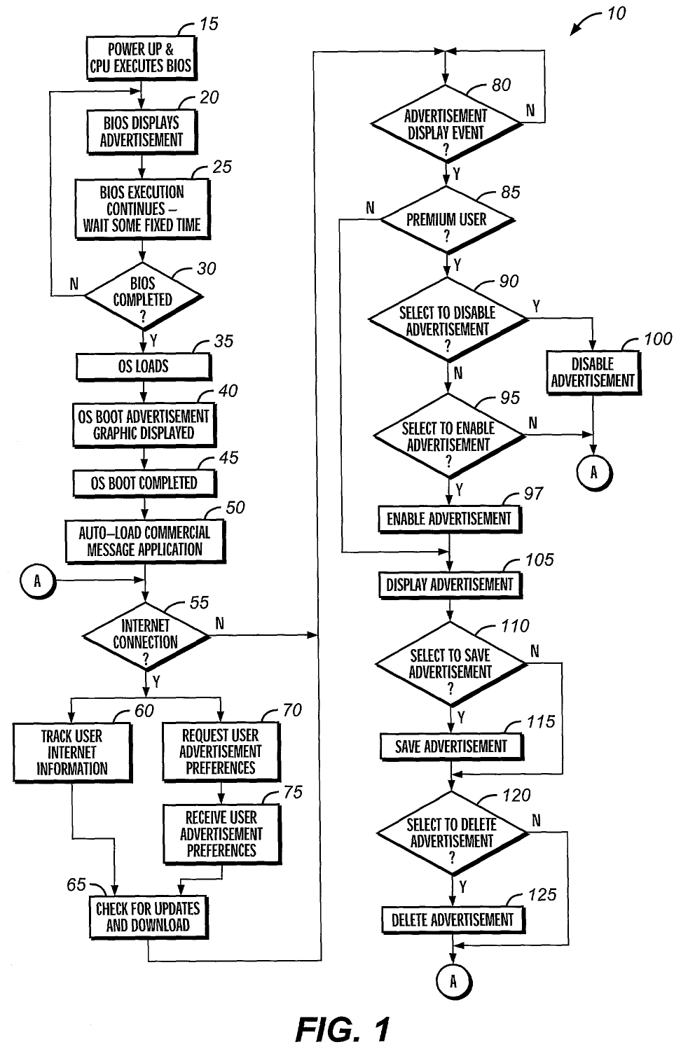

The aspects above are described in more detail with reference to the figures. Turning to FIG. 1, an exemplary technique 10 for displaying a commercial message on a display device of a computer during the user waiting time is illustrated. In block 15, when the computer power is turned on, the microprocessor 505 of a computer 500 executes the commercial message BIOS 535 residing in memory 520 (see FIG. 3). In block 20, a commercial message application 540 executes and begins displaying advertisements stored in the memory 520. The user waiting period is boot-up time in this instance. In block 25, the BIOS execution continues to perform its normal functions, and waits some fixed period of time. In block 30, the BIOS checks to determine if the BIOS execution has been completed. If the BIOS execution has not completed, the control returns to block 20 where the BIOS continues to display the advertisement. If the BIOS execution has completed, the operating system (OS) loading is initiated in block 35. In block 40, during the OS boot, advertisements are again displayed. It is to be noted that up to this point, advertisement display has been under the control of the BIOS. After the BIOS has completed its tasks, control of the computer 500 is transferred to the OS. In block 45, when the OS boot is completed, a commercial message application is automatically loaded in block 50. A commercial message application 540 may operate in the background with respect to the OS. The power-down mode or sleep-mode may be designed to be preferably compliant with any Advanced Configuration and Power Interface specification (ACPI) as co-developed by Compaq, Intel, Microsoft, Phoenix, and Toshiba. An ACPI specification establishes industry-standard interfaces for OS-directed configuration and power management of computers. The commercial message application 540 can be designed to detect an ACPI wake-up event from a sleep mode and initiate advertisements on the display 510. Likewise, the application 540 is designed to recognize when the wake-up period is complete and to return control to the OS.

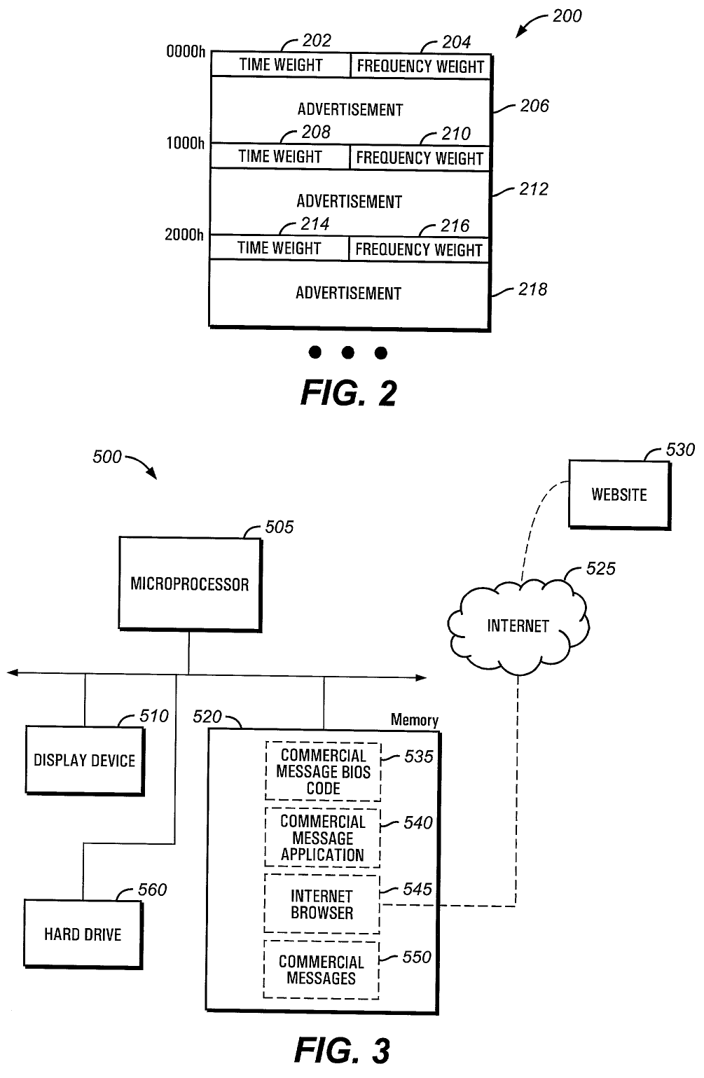

In block 50, the commercial message application 50 checks to see if the computer system 500 is connected to the Internet. If no Internet connection exists, the commercial message application 50 checks to see if it is an advertisement display event in block 80. If not, the control remains in block 80. If yes, the control is transferred to block 85 to check if the computer 500 user is a premium user. A premium user is one who might have paid an additional premium to be able to exercise control over advertisement display. The manufacturer may track the premium user status by tracking the computer serial number or by imbedding a unique code in the memory 200 (FIG. 2). If the user is a premium user, the control from block 85 is transferred to block 90 where the premium user is provided an option to disable the advertisement. If the premium user elects to disable the advertisement, the control transfers to block 100 where the advertisement feature is disabled. However, if the premium user elects not to disable the advertisement feature, the user is provided a choice to enable the advertisement as shown in block 95. If the premium user elects to enable the advertisement in block 97, the advertisement feature is enabled and the control is transferred to block 105 and the advertisements are displayed. On some occasions, the premium user or other user may find an advertisement interesting and may want to save it on a hard drive or a floppy drive for future use or transfer to another location. That user is given an option to save the advertisement as shown in block 110. If the user elects to save a particular advertisement, that advertisement is saved as shown in block 115. Thus the user selectively saves the commercial messages and can later selectively play or transfer the saved messages. If the user elects not to save the particular advertisement, the control is returned to block 120. If the user is a premium user, in block 120, the user is provided with a choice of deleting a particular advertisement. If that premium user elects to delete the particular advertisement, such advertisement is deleted in block 125 and the control is transferred to block 55. If the user is not a premium user, or if a premium user elects to enable the advertisement, the control is transferred to block 105 to display the advertisement.

Returning back to block 55, if an Internet connection to the system 500 exists, the user may occasionally request to provide advertisement preferences as shown in block 70. By requesting for user preferences the commercial message application 550 builds by asking questions or accepting specific user requests, and stores the user profile, and as discussed later, updates the profile periodically or continuously. One exemplary technique of detecting whether the computer is connected to the Internet is illustrated in a co-assigned patent application entitled “DIGITAL FEEDBACK DISPLAY PANEL AND SUPPORTING SOFTWARE FOR A COMPUTER USER,” U.S. application Ser. No. 09/478,153, filed Jan. 5, 2000. In such event, the commercial message application receives user advertisement preferences in block 75. After receiving user advertisement preferences, the application in block 65 checks for advertisement updates and downloads advertisements according to those user preferences from the Internet. The computer manufacturer may also check for updates and downloads in block 65 via a manufacturer password that only the manufacturer or its authorized agent possesses. One exemplary technique of secure remote downloading of data to a flash ROM of a computer is illustrated in co-assigned U.S. Pat. No. 6,223,284, entitled “METHOD AND APPARATUS FOR REMOTE ROM FLASHING AND SECURITY MANAGEMENT FOR A COMPUTER SYSTEM,” issued Apr. 24, 2001. In an embodiment, the computer manufacturer can securely access the memory 520 through the Internet by presenting a password residing therein. The password may be used by the computer manufacturer or its authorized agent for securely updating the memory 520. As an alternative to block 70, the control from block 55 may transfer to block 60 where the commercial message application 540 tracks the user Internet information, like the user preferences and update the user profile. The commercial message application 50 accordingly checks for an updates and securely downloads from the Internet. In block 80, the commercial message application checks whether there is an advertisement display event, like the computer going into a sleep mode, waking up from a sleep mode, initiation of a virus scan, initiation of a screen saver, initiation of download of a large file, initiation of a software installation, or other such events where the user may encounter an idle time or wait period. If such an event occurs, the application 50 begins an advertisement display in block 105.

Now referring to FIG. 2, an exemplary embodiment of the system of assigning duration and frequency of displaying commercial messages on the computer display 510 is illustrated. The FIG. 2 illustrates a non-volatile memory 200, for example a flash read only memory (ROM), or NVRAM. Note that advertisements can be of fixed time or variable time size. An advertisement 206 in memory block 0000h is preceded by a memory block 202 indicating the time weight and the memory block 204 indicating the frequency weight for the advertisement 206. Similarly, advertisement 220 in memory block 1000h has a time weight 208 and frequency weight 210. A third example advertisement 218 stored in memory block 2000h has a time weight 214 and a frequency weight 216. Any number of the suitable criteria for displaying advertisements may be used to display the advertisements in memory 2000. For example, advertisements 206, 212, and 218 may each be assigned a time weight equal to their corresponding duration, however, their frequency weight may be assigned according to the revenue generating capacity, or revenue received for each advertisement message. In one embodiment, the advertisements 206, 212, and 218 may be sequentially displayed or randomly sequenced with the corresponding frequency weights 204, 210, and 216, one possible objective being to maximize the revenue while including free educational information like computer productively tips and other useful attractive information while maintaining user interest. Again, the time weight and the frequency weight are controlled by the manufacturer or its authorized agent through a password that can be used via the Internet.

With reference to FIG. 3, an exemplary embodiment of a computer system 500 for displaying a commercial message on a computer display 510 during the user waiting time is illustrated. The computer system 500 includes a microprocessor or microcontroller 505 coupled to the display device 510 and also coupled a memory 520. The display device 510 may, for example, be a desktop monitor or other video display that is commercially available. The microprocessor 505, for example, may be an Intel Pentium processor, an AMD processor, future Itanium models of processors or any other suitable processor. The memory 520 includes an advertisement message BIOS code 535, an Internet or web browser 545, for example Internet Explorer or Netscape, a commercial message application 540, and commercial messages 550. The BIOS code 535 controls display 540 of messages during the boot-up waiting period and the commercial message application 540, controls display of messages under control of the OS. The memory 520 may be non-volatile random access memory (NVRAM) or a flash ROM. The Internet browser 545 can be connected with the Internet 525 by the user, and the user can access a website 530 through the Internet 525. The memory 520 stores and provides the commercial messages. Alternatively, when the computer 500 displays messages while under control of the OS, the commercial messages may be stored and played from a hard drive 560. The commercial messages display is non-intrusive to the user's normal activities because the commercial message application 540 detects the user waiting period and only then elects to display commercial messages during such user waiting period. The term “computer” as used herein includes information appliances with a subset of computing functions associated with a general purpose computer.

The foregoing disclosure and description of the various embodiments are illustrative and explanatory thereof, and various changes in the components, circuit elements, circuit configurations, and signal connections, as well as in the details of the illustrated circuitry and construction and method of operation may be made without departing from the spirit and scope of the invention.

We claim:

1. A method of displaying a commercial message on a display device of a computer during a user waiting time, the method comprising the steps of:
selecting the commercial message from a non-volatile memory; and
displaying the selected commercial message on the display device during the user waiting time.

2. The method as in claim 1, wherein the commercial message comprises an advertisement message.

3. The method as in claim 1, wherein the commercial message comprises productivity enhancement tips for the computer.

4. The method as in claim 1, wherein the step of selecting the commercial message further comprises the steps of:
tracking Internet information associated with the computer; and
choosing the commercial message to download to the non-volatile memory from a website based on the Internet information.

5. The method as in claim 1, wherein the user waiting time comprises a computer boot time.

6. The method as in claim 1, wherein the user waiting time comprises a computer wake-up time from a low power mode.

7. The method as in claim 1, wherein the user waiting time comprises a computer screen saver time.

8. The method as in claim 1, wherein the user waiting time comprises a virus-scan time of a storage medium of the computer.

9. The method as in claim 1, wherein the commercial message is displayed for a duration according to a time weight assigned to the commercial message.

10. The method as in claim 1, wherein the commercial message is repeated according to a frequency weight assigned to the commercial message.

11. A computer system for displaying a commercial message on a display device during a user waiting time, the computer system comprising:
a display device;
a processor coupled to the display device; and
a memory coupled to the processor and containing code adapted to display the commercial message during the user waiting time.

12. The computer system as in claim 11, wherein the memory comprises a flash read-only memory (ROM).

13. The computer system as in claim 11, wherein the memory comprises a hard drive.

14. The computer system as in claim 11, wherein the memory is updated with the commercial message from the Internet when the computer is connected to a website.

15. The computer system as in claim 11, wherein the code comprises Basic Input/Output System (BIOS) code.

16. The computer system as in claim 11, wherein the code comprises a commercial messaging application.

17. The computer system as in claim 11, wherein displaying the commercial message in the memory is selectively disabled.

18. The computer system as in claim 11, wherein deletion of the commercial message in the memory is selectively enabled.

19. The computer system as in claim 11, wherein display of the commercial message is selectively disabled.

20. The computer system as in claim 11, wherein the commercial message is selectively saved for future display on the display device.

21. The computer system as in claim 11, wherein the type of commercial message is user selectable.

22. A non-intrusive computer-based system for displaying commercial messages, the system comprising:
a means for detecting a user waiting time of a computer; and
a means for selecting a commercial message to display on the computer during the user waiting time.

23. The system of claim 22, wherein the user waiting time comprises a boot time of the computer.

24. The system of claim 22, wherein the user waiting time comprises a wake-up time from a low-power mode of the computer.

25. The system of claim 22, wherein the user waiting time comprises a virus-scan time of a storage medium of the computer.

26. The system of claim 22, wherein the commercial message comprises an advertisement message.
